(19) United States
(12) Patent Application Publication
(10) Pub. No.: US 2022/0069696 A1
(43) Pub. Date: Mar. 3, 2022

(54) CONVERTER DEVICE AND POWER SUPPLY DEVICE

(71) Applicant: TDK CORPORATION, Tokyo (JP)

(72) Inventor: Eiji TAKEGAMI, Tokyo (JP)

(73) Assignee: TDK CORPORATION, Tokyo (JP)

(21) Appl. No.: 17/399,149

(22) Filed: Aug. 11, 2021

(30) Foreign Application Priority Data
Aug. 25, 2020 (JP) 2020-141830

(51) Int. Cl. H02M 1/08; H02M 3/158; H02M 3/335; H02M 1/00

(52) U.S. Cl. CPC H02M 1/08; H02M 3/158; H02M 1/0009; H02M 1/007; H02M 3/33569

(57) ABSTRACT

A converter device includes a plurality of converters, a voltage detector, a temperature detector, and a controller. The plurality of converters are connected in series or in parallel. Each of the plurality of converters includes at least one switch element controlled according to a drive signal. The voltage detector detects information about an output voltage of a converter circuit unit in which the plurality of converters are connected. The temperature detector detects information about temperatures of one or more of semiconductor elements including the switch element in each of the plurality of converters. The controller controls the drive signal for the switch element in each converter so that temperatures of semiconductor elements having highest temperatures in the plurality of converters are closed to each other on the basis of detection results of the voltage detector and detection results of the temperature detector.

### CROSS-REFERENCE TO RELATED APPLICATION

Priority is claimed on Japanese Patent Application No. 2020-141830, filed Aug. 25, 2020, the content of which is incorporated herein by reference.

### BACKGROUND OF THE INVENTION

### Field of the Invention

The present disclosure relates to a converter device and a power supply device.

### Description of Related Art

In Patent Document 1, a multi-phase direct current (DC)/DC converter in which a plurality of converters (phase circuits) are connected in parallel in a power supply device is disclosed (see Patent Document 1). In the multi-phase DC/DC converter described in Patent Document 1, output terminals of the plurality of converters are connected in parallel and a current balance in each converter is controlled by performing control so that a switching frequency of a control signal for turning on/off a switch element in each converter is lowered. In the multi-phase DC/DC converter described in Patent Document 1, a weight of a load is determined on the basis of a load current flowing through the load and the switching frequency is controlled on the basis of the weight of the load.

### PATENT DOCUMENTS

[Patent Document 1] Japanese Unexamined Patent Application, First Publication No. 2006-340442

### SUMMARY OF THE INVENTION

However, in the conventional technology, when a heat generation quantity of the switch element in each converter is not identical, the output power may be limited by the switch element having high heat generation.

Although the current balance in each converter is controlled on the basis of the current detection result in the multi-phase DC/DC converter described in Patent Document 1, a process of detecting the temperature of the switch element in each converter is not performed.

The present disclosure has been made in consideration of such circumstances, and an objective of the present disclosure is to provide a converter device and a power supply device capable of balancing temperatures of switch elements in a plurality of converters.

According to an aspect, there is provided a converter device including: a plurality of converters; a voltage detector; a temperature detector; and a controller, wherein the plurality of converters are connected in series or in parallel, wherein each of the plurality of converters includes at least one switch element configured to be controlled according to a drive signal, wherein the voltage detector is configured to detect information about an output voltage of a converter circuit unit in which the plurality of converters are connected, wherein the temperature detector is configured to detect information about temperatures of one or more of semiconductor elements including the switch element in each of the plurality of converters, and wherein the controller is configured to control the drive signal for the switch element in each converter so that temperatures of semiconductor elements having highest temperatures in the plurality of converters are closed to each other on the basis of detection results of the voltage detector and detection results of the temperature detector.

According to an aspect, there is provided a power supply device including: the converter device; and a power supply unit configured to supply a direct current (DC) power to the converter device.

According to the present disclosure, in the converter device and the power supply device, temperatures of switch elements in a plurality of converters can be balanced.

### BRIEF DESCRIPTION OF THE DRAWINGS

FIG. 1 is a diagram showing a circuit configuration of a power supply device including a converter device according to an embodiment (first to fourth embodiments).

FIG. 2 is a diagram showing an example of a configuration of an operation voltage generator in a voltage mode in a pulse width modulation (PWM) unit according to the embodiment (the first embodiment).

FIG. 3 is a diagram showing an example of a configuration of an operation voltage generator in a voltage mode in a PWM unit according to the embodiment (the second embodiment).

FIG. 4 is a diagram showing an example of a configuration of an operation voltage generator in a voltage mode in a PWM unit according to the embodiment (the third embodiment).

FIG. 5 is a diagram showing an example of a configuration of an operation voltage generator in a voltage mode in a PWM unit according to the embodiment (the fourth embodiment).

FIG. 6 is a diagram showing a circuit configuration of a power supply device including a converter device according to an embodiment (a fifth embodiment).

FIG. 7 is a diagram showing a circuit configuration of a power supply device including a converter device according to an embodiment (a sixth embodiment).

FIG. 8 is a diagram showing a circuit configuration of a power supply device including a converter device according to an embodiment (a seventh embodiment).

FIG. 9 is a diagram showing a circuit configuration of the power supply device including the converter device according to the embodiment (the first to fourth embodiments) and an available current detection position of a current transformer in each converter.

FIG. 10 is a diagram showing a circuit configuration of the power supply device including the converter device according to the embodiment (the fifth embodiment) and an available current detection position of a current transformer in each converter.

FIG. 11 is a diagram showing a circuit configuration of the power supply device including the converter device according to the embodiment (the sixth embodiment) and an available current detection position of a current transformer in each converter.

FIG. 12 is a diagram showing a circuit configuration of the power supply device including the converter device according to the embodiment (the seventh embodiment) and an available current detection position of a current transformer in each converter.

### DETAILED DESCRIPTION OF THE INVENTION

Hereinafter, embodiments of the present disclosure will be described with reference to the drawings.

### First Embodiment

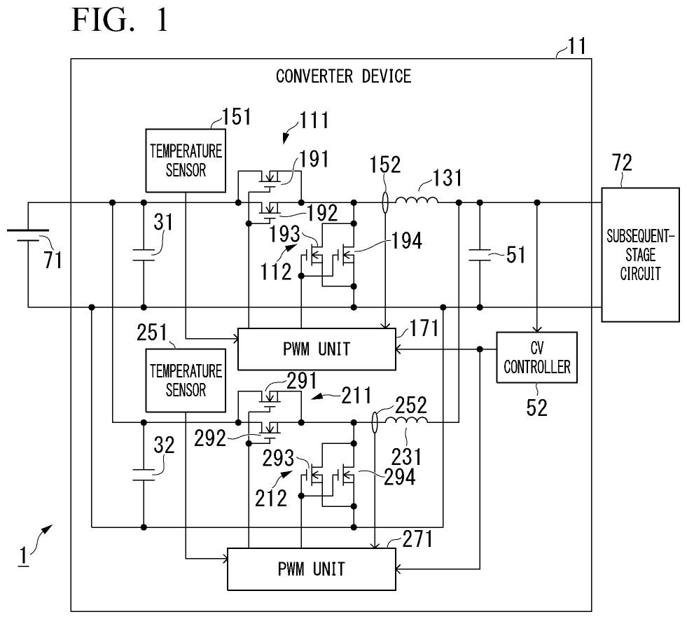

FIG. 1 is a diagram showing a circuit configuration of a power supply device 1 including a converter device 11 according to an embodiment (first to fourth embodiments).

The power supply device 1 includes the converter device 11 and a voltage source 71.

Also, in FIG. 1, a subsequent-stage circuit 72, which is a circuit connected to a stage subsequent to the converter device 11, is shown.

Although an example of a configuration in which the subsequent-stage circuit 72 is not included in the power supply device 1 is shown in the present embodiment, the subsequent-stage circuit 72 may be included in the power supply device 1 as another example of the configuration.

The voltage source 71 functions as a power supply unit for supplying electric power and is provided in a stage previous to the converter device 11.

In the present embodiment, the voltage source 71 is a direct current (DC) voltage source that supplies DC power based on a DC voltage. As another example of the configuration, the voltage source 71 may be configured using an alternating current (AC) voltage source and a circuit that converts an AC voltage output from the AC voltage source into a DC voltage.

Also, as another example of the configuration, a current source that supplies DC power based on a DC current may be used instead of the voltage source 71.

The converter device 11 includes a converter circuit unit including two converters. In the present embodiment, for convenience of description, the above two converters will be referred to as a first converter and a second converter, respectively.

The first converter and the second converter are converters that are not isolated (also referred to as non-isolated converters for convenience of description), respectively.

The first converter includes a switch unit 111, a switch unit 112, a coil 131 that functions as a choke coil, a temperature sensor 151 constituting a temperature detector, a current detection circuit 152 constituting a current detector, and a pulse width modulation (PWM) unit 171 constituting a controller.

Here, the converter device 11 includes a capacitor 31 in a stage previous to the first converter.

Although an example of a configuration in which the capacitor 31 is not included in the first converter is shown in the present embodiment, the capacitor 31 may be included in the first converter as another example of the configuration.

The switch unit 111 includes a switch element 191 and a switch element 192.

The switch unit 112 includes a switch element 193 and a switch element 194.

In the present embodiment, each of the switch elements 191 to 194 is configured using a field effect transistor (FET).

The second converter includes a switch unit 211, a switch unit 212, a coil 231 that functions as a choke coil, a temperature sensor 251 constituting a temperature detector, a current detection circuit 252 constituting a current detector, and a PWM unit 271 constituting a controller.

Here, the converter device 11 includes a capacitor 32 in a stage previous to the second converter.

Although an example of a configuration in which the capacitor 32 is not included in the second converter is shown in the present embodiment, the capacitor 32 may be included in the second converter as another example of the configuration.

The switch unit 211 includes a switch element 291 and a switch element 292.

The switch unit 212 includes a switch element 293 and a switch element 294.

In the present embodiment, each of the switch elements 291 to 294 is configured using a field effect transistor (FET).

The converter device 11 includes a capacitor 51 serving as an output capacitor of a subsequent stage and a constant voltage (CV) controller 52 including a voltage detector common between the first converter and the second converter.

The subsequent-stage circuit 72 may be, for example, a load or another circuit. The other circuit may be, for example, a circuit of a converter. In this case, the converter is also disposed in a stage subsequent to the converter device 11.

A connection relationship between parts in the power supply device 1 will be described.

Regarding the first converter, the capacitor 31 of an input side is connected in parallel to the voltage source 71.

Regarding the second converter, the capacitor 32 of an input side is connected in parallel to the voltage source 71.

That is, each of the capacitor 31 and the capacitor 32 is connected between a high-potential side and a low-potential side of two output terminals of the voltage source 71.

The first converter will be described.

The high-potential side of both terminals of the capacitor 31 is connected to a drain terminal of the switch element 191 and a drain terminal of the switch element 192.

The switch element 191 and the switch element 192 are disposed in parallel.

A source terminal of the switch element 191 and a source terminal of the switch element 192 are connected to one end of the coil 131 via the current detection circuit 152.

A capacitor 51 of an output side is connected between the other end of the coil 131 and the low-potential side of both terminals of the capacitor 31.

The drain terminal of the switch element 193 and the drain terminal of the switch element 194 are connected to the source terminal of the switch element 191 and the source terminal of the switch element 192. The switch element 193 and the switch element 194 are disposed in parallel.

The source terminal of the switch element 193 and the source terminal of the switch element 194 are connected to the low-potential side of both terminals of the capacitor 31.

Here, one terminal (drain terminal) of each of the switch elements 191 and 192 constituting one switch unit 111 is connected to the high-potential side of the two output terminals of the voltage source 71 and one terminal (source terminal) of each of the switch elements 193 and 194 constituting the other switch unit 112 is connected to the low-potential side of the two output terminals of the voltage source 71.

In the present embodiment, among the semiconductor elements including the switch elements 191 to 194 in the first converter, the component closest to a maximum rated temperature is identified. The temperature sensor 151 is disposed at a position where the temperature of the component closest to the maximum rated temperature can be detected in this way. In the example of FIG. 1, as an example, the switch element 191 or the switch element 192 is a component closest to the maximum rated temperature and the temperature sensor 151 is disposed in the vicinity of the switch elements 191 and 192.

The current detection circuit 152 is connected between the source terminal of the switch element 191 and the source terminal of the switch element 192 and the coil 131. As the current detection circuit 152, a current transformer is used in the present embodiment, and a Hall element, a shunt resistor, or the like may be used as another example.

The PWM unit 171 may be disposed at any location.

The second converter will be described.

The high-potential side of both terminals of the capacitor 32 is connected to a drain terminal of the switch element 291 and a drain terminal of the switch element 292. The switch element 291 and the switch element 292 are disposed in parallel.

A source terminal of the switch element 291 and a source terminal of the switch element 292 are connected to one end of the coil 231 via the current detection circuit 252.

The capacitor 51 of the output side is connected between the other end of the coil 231 and the low-potential side of both terminals of the capacitor 32.

A drain terminal of the switch element 293 and a drain terminal of the switch element 294 are connected to the source terminal of the switch element 291 and the source terminal of the switch element 292. The switch element 293 and the switch element 294 are disposed in parallel.

The source terminal of the switch element 293 and the source terminal of the switch element 294 are connected to the low-potential side of both terminals of the capacitor 32.

Here, one terminal (drain terminal) of each of the switch elements 291 and 292 constituting one switch unit 211 is connected to the high-potential side of the two output terminals of the voltage source 71 and one terminal (source terminal) of each of the switch elements 293 and 294 constituting the other switch unit 212 is connected to the low-potential side of the two output terminals of the voltage source 71.

In the present embodiment, among the semiconductor elements including the switch elements 291 to 294 in the second converter, the component closest to the maximum rated temperature is identified. The temperature sensor 251 is disposed at a position where the temperature of the component closest to the maximum rated temperature can be detected in this way. In the example of FIG. 1, as an example, the switch element 291 or the switch element 292 is a component closest to the maximum rated temperature and the temperature sensor 251 is disposed in the vicinity of the switch elements 291 and 292.

The current detection circuit 252 is connected between the source terminal of the switch element 291 and the source terminal of the switch element 292 and the coil 231. As the current detection circuit 252, a current transformer is used in the present embodiment, and a Hall element, a shunt resistor, or the like may be used as another example.

The PWM unit 271 may be disposed at any location.

On the output side of the first converter, an end that is opposite an end to which the switch units 111 and 112 are connected between both ends of the coil 131 becomes the end of the high-potential side.

On the output side of the second converter, an end that is opposite an end to which the switch units 211 and 212 are connected between both ends of the coil 231 becomes the end of the high-potential side.

The end of the high-potential side on the output side of the first converter is connected to the end of the high-potential side on the output side of the second converter. Also, the end of the low-potential side on the output side of the first converter is connected to the end of the low-potential side on the output side of the second converter. Thereby, the first converter and the second converter are connected in parallel.

The capacitor 51 of the output side is connected between the end of the common high-potential side and the end of the common low-potential side on the output side in the first converter and the second converter.

The subsequent-stage circuit 72 is connected to a stage subsequent to the capacitor 51 of the output side common between the first converter and the second converter.

In the stage subsequent to the capacitor 51 of the output side, the CV controller 52 is connected to the capacitor 51 of the output side.

The PWM control in the converter device 11 will be described.

The PWM unit 171 of the first converter will be described.

The CV controller 52 controls a control quantity (also referred to as a manipulation quantity for convenience of description) to be output to the PWM unit 171 so that the voltage applied across both terminals of the capacitor 51 on the output side becomes constant. Also, as the operation of the CV controller 52, for example, an operation similar to that of the conventional case may be performed.

The temperature sensor 151 outputs information about a detected temperature to the PWM unit 171. The information may be, for example, information representing a value of the detected temperature or other information based on the value of the detected temperature.

The current detection circuit 152 detects a current flowing through the current detection circuit 152 and outputs a current detection result to the PWM unit 171. In the example of FIG. 1, the current is a current flowing through the switch unit 111 (a parallel connection portion of the two switch elements 191 and 192) and is a current flowing through the coil 131.

The PWM unit 171 controls a control voltage (a drive signal) that is output to a gate terminal of the switch element 191 and a gate terminal of the switch element 192 and a control voltage (a drive signal) that is output to a gate terminal of the switch element 193 and a gate terminal of the switch element 194 so that the temperature detected by the temperature sensor 151 is closed to a predetermined value on the basis of information about the voltage input from the CV controller 52 and information about the temperature input from the temperature sensor 151. The predetermined value may be, for example, a constant value or another value.

Also, the PWM unit 171 may further control the control voltage (the drive signal) that is output to the gate terminal of the switch element 191 and the gate terminal of the switch element 192 and the control voltage (the drive signal) that is output to the gate terminal of the switch element 193 and the gate terminal of the switch element 194 on the basis of information about a current (a current detection result) input from the current detection circuit 152.

In the present embodiment, a common control voltage is used between the switch element 191 and the switch element 192 and a common control voltage is used between the switch element 193 and the switch element 194.

The PWM unit 271 of the second converter will be described.

The CV controller 52 controls a control quantity (also referred to as a manipulation quantity for convenience of description) to be output to the PWM unit 271 so that the voltage applied across both terminals of the capacitor 51 of the output side becomes constant. As the operation of the CV controller 52, for example, an operation similar to that of the conventional case may be performed.

The temperature sensor 251 outputs information about the detected temperature to the PWM unit 271. The information may be, for example, information representing the value of the detected temperature or other information based on the value of the detected temperature.

The current detection circuit 252 detects a current flowing through the current detection circuit 252 and outputs a current detection result to the PWM unit 271. In the example of FIG. 1, the current is a current flowing through the switch unit 211 (a parallel connection portion of the two switch elements 291 and 292) and is a current flowing through the coil 231.

The PWM unit 271 controls a control voltage (a drive signal) that is output to a gate terminal of the switch element 291 and a gate terminal of the switch element 292 and a control voltage (a drive signal) that is output to a gate terminal of the switch element 293 and a gate terminal of the switch element 294 so that the temperature detected by the temperature sensor 251 is closed to a predetermined value on the basis of information about the voltage input from the CV controller 52 and information about the temperature input from the temperature sensor 251. The predetermined value may be, for example, a constant value or another value.

Also, the PWM unit 271 may further control the control voltage (the drive signal) that is output to the gate terminal of the switch element 291 and the gate terminal of the switch element 292 and the control voltage (the drive signal) that is output to the gate terminal of the switch element 293 and the gate terminal of the switch element 294 on the basis of information about a current (a current detection result) input from the current detection circuit 252.

In the present embodiment, a common control voltage is used between the switch element 291 and the switch element 292, and a common control voltage is used between the switch element 293 and the switch element 294.

Here, in the present embodiment, the manipulation quantity from the CV controller 52 to the PWM unit 171 and the manipulation quantity from the CV controller 52 to the PWM unit 271 are the same.

In the present embodiment, the configuration of the PWM unit 171 of the first converter is similar to the configuration of the PWM unit 271 of the second converter.

Here, the configuration of the PWM unit 171 will be described.

Also, as the current detection circuits 152 and 252, for example, a non-contact element (for example, a Hall element) such as a magnetic sensor may be used. In general, non-contact current detection by a non-contact element is implemented with low accuracy in low loss, so that high efficiency can be achieved when the non-contact element is used.

Although a circuit configuration in which the current is detected in each of the two converters is shown in the example of FIG. 1, a configuration in which a current is detected in one converter, a total current obtained by combining currents of the two converters is detected by a shunt resistor or the like, and a current of a result of subtracting the current in the one converter from the total current is estimated as a current in the other converter may be used as another example of the configuration. In this case, the shunt resistor is provided at a location where the total current obtained by combining the currents of the two converters flows.

As an example, in the parallel connection (interleave) of the two converters, a configuration in which an element (a non-contact element) that performs non-contact current detection is used as the current detection circuit 152 in the one converter and the current in the other converter is estimated as the current of the result of subtracting the detected current in the one converter from the total current may be used.

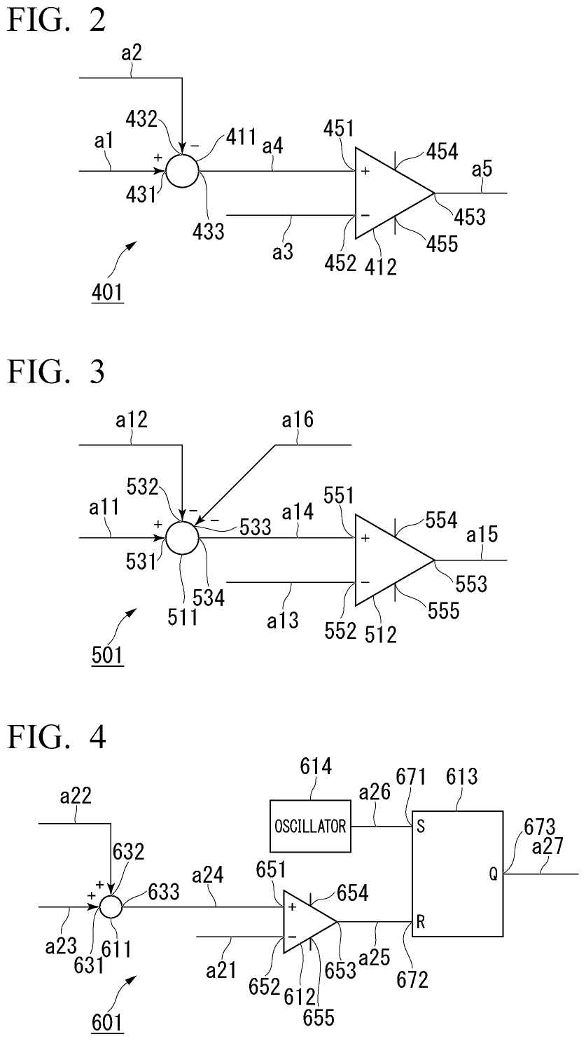

FIG. 2 is a diagram showing an example of a configuration of an operation voltage generator 401 in a voltage mode in the PWM unit 171 according to the embodiment (the first embodiment).

The operation voltage generator 401 includes a calculator 411 and a comparator 412.

The calculator 411 has a positive input terminal 431, a negative input terminal 432, and an output terminal 433.

The comparator 412 has a positive input terminal 451 and a negative input terminal 452, an output terminal 453, a positive power supply terminal 454, and a negative power supply terminal 455.

A manipulation quantity a1 output from the CV controller 52 is input to the positive input terminal 431 of the calculator 411.

Information about the temperature output from the temperature sensor 151 (referred to as temperature information a2 for convenience of description) is input to the negative input terminal 432 of the calculator 411.

The calculator 411 performs a calculation operation of subtracting the temperature information a2 from the manipulation quantity a1 and outputs a calculation result a4 from the output terminal 433 to the comparator 412.

Predetermined carrier information a3 is input to the negative input terminal 452 of the comparator 412. Here, as the carrier information a3, information of carrier waves in PWM is used, and for example, triangular waves are used.

The calculation result a4 output from the calculator 411 is input to the positive input terminal 451 of the comparator 412.

The comparator 412 outputs a comparison result a5 based on a magnitude relationship between the carrier information a3 and the calculation result a4.

In the present embodiment, a control voltage based on the comparison result a5 is input as a PWM control voltage to the gate terminals of the switch elements 191 and 192.

Also, the PWM unit 171 outputs a control voltage obtained by inverting the control voltage for the switch elements 191 and 192 to the gate terminals of the switch elements 193 and 194. Thereby, the switch elements 191 and 192 and the switch elements 193 and 194 are controlled so that their on/off operations are reversed from each other.

Also, the PWM unit 271 of the second converter controls the control voltage for the gate terminals of the switch elements 291 and 292 and the control voltage for the gate terminals of the switch elements 293 and 294 as in the control described with respect to the PWM unit 171 of the first converter.

Here, in the present embodiment, a case in which the PWM unit 171 of the first converter performs control on the basis of the detection result of the temperature sensor 151 and the PWM unit 271 of the second converter performs control on the basis of the detection result of the temperature sensor 251 is shown.

As another example of the configuration, a configuration in which each of the PWM unit 171 of the first converter and the PWM unit 271 of the second converter performs control on the basis of both the detection result of the temperature sensor 151 and the detection result of the temperature sensor 251 may be used.

In this case, for example, information about the detected temperature is also output from the temperature sensor 151 of the first converter to the PWM unit 271 of the second converter. Likewise, information about the detected temperature is also output from the temperature sensor 251 of the second converter to the PWM unit 171 of the first converter. In the operation voltage generator 401 shown in FIG. 2, temperature difference information is used instead of the temperature information a2.

The temperature difference information is information representing a difference between the temperature detected by the temperature sensor 151 of the first converter and the temperature detected by the temperature sensor 251 of the second converter and is generated in, for example, the PWM units 171 and 271.

Although the converter device 11 separately includes the PWM unit 171 of the first converter and the PWM unit 271 of the second converter in the present embodiment, some or all of functions provided in the PWM units 171 and 271 may be provided in a common controller as another example of the configuration.

As another example of the configuration, a controller that controls the PWM unit 171 of the first converter and the PWM unit 271 of the second converter may be provided. The controller may be configured using, for example, a microcomputer (a microcontroller unit (MCU)) or the like, information input to the PWM units 171 and 271 in the example of FIG. 2 is input to the microcomputer, the PWM units 171 and 271 may be controlled on the basis of the input information, and an operation voltage (a drive signal) similar to that of the present embodiment may be generated.

For example, the controller that controls the PWM units 171 and 271 or the PWM units 171 and 271 may input information of temperatures detected by the temperature sensors 151 and 251 in the two converters and perform control so that the temperature difference between the two converters is closed to zero (0). As another example of the configuration, for example, the controller that controls the PWM units 171 and 271 or the PWM units 171 and 271 may input the information of the temperatures detected by the temperature sensors 151 and 251 in the two converters and perform control so that the temperature in each converter is closed to a predetermined value such as an average value between the temperatures in the two converters.

Here, the circuit configuration of the operation voltage generator 401 shown in FIG. 2 is an example, and for example, another circuit configuration that can obtain a similar control voltage (drive signal) may be used. For example, the temperature information a2 (or temperature difference information) may be introduced at another location such as a location of the carrier information a3.

Also, plus (+) and minus (−) signs of the signal may be adjusted by, for example, an inverting circuit.

In the example of FIG. 2, for example, the converter device 11 may not include the current detection circuit 152 and the current detection circuit 252.

As described above, in the power supply device 1 according to the present embodiment, the PWM units 171 and 271 in the plurality of converters control the drive signal for the switch element in each converter so that temperatures of the semiconductor elements having highest temperatures in the plurality of converters are closed to each other on the basis of the output voltage detection result and the temperature detection result.

According to the above configuration, in the power supply device 1 according to the present embodiment, in the output circuit according to a parallel connection of the non-isolated converters, it is possible to perform control so that the temperatures of the switch elements are balanced by the PWM control of the voltage mode. Thereby, in the converter device 11, the balance between the temperatures can be retained for the plurality of converters.

Therefore, in the power supply device 1 according to the present embodiment, the temperatures of the switch elements of the plurality of converters can be balanced.

Although converters having the same circuit configuration are used as a plurality of converters in the converter device 11 in the present embodiment, converters having different circuit configurations may be used as another example of the configuration.

Although a case in which two converters are connected in parallel in the converter device 11 is shown in the present embodiment, a configuration in which three or more converters are connected in parallel may be used as another example of the configuration.

When three or more converters are used, it is only necessary to use, for example, information of a difference between temperatures in at least two converters, as the temperature difference information. As the temperature difference information, the information of the difference between temperatures of the two converters for all combinations of the two converters may be used or other forms may be used.

Likewise, when three or more converters are used, it is only necessary to use, for example, information of a difference between currents in at least two converters as current difference information. As the current difference information, the information of the difference between currents of the two converters for all combinations of the two converters may be used or other forms may be used.

### Second Embodiment

A schematic configuration of a power supply device according to the present embodiment is similar to that of the power supply device 1 shown in FIG. 1 according to the first embodiment. Thus, for convenience of description, the present embodiment will be described using reference signs which are the same as those of the parts shown in FIG. 1 with reference to the power supply device 1 shown in FIG. 1.

Also, in the present embodiment, the configurations of the PWM units 171 and 271 are schematically different from those of the first embodiment and the others are similar to those of the first embodiment. Therefore, the description of the similarities will be omitted or simplified.

Here, in the present embodiment, a manipulation quantity from a CV controller 52 to the PWM unit 171 and a manipulation quantity from the CV controller 52 to the PWM unit 271 are the same.

In the present embodiment, the configuration of the PWM unit 171 of a first converter is similar to the configuration of the PWM unit 271 of a second converter.

Here, the configuration of the PWM unit 171 will be described.

FIG. 3 is a diagram showing an example of a configuration of an operation voltage generator 501 of a voltage mode in the PWM unit 171 according to the embodiment (the second embodiment).

The operation voltage generator 501 includes a calculator 511 and a comparator 512.

The calculator 511 has a positive input terminal 531, a negative input terminal 532, a negative input terminal 533, and an output terminal 534.

The comparator 512 has a positive input terminal 551, a negative input terminal 552, an output terminal 553, a positive power supply terminal 554, and a negative power supply terminal 555.

A manipulation quantity all output from the CV controller 52 is input to the positive input terminal 531 of the calculator 511.

Information about a temperature output from a temperature sensor 151 (referred to as temperature information a12 for convenience of description) is input to the negative input terminal 532 of the calculator 511.

Information about the current input from a current detection circuit 152 to the PWM unit 171 (referred to as current information a16 for convenience of description) is input to the negative input terminal 533 of the calculator 511.

The calculator 511 performs a calculation operation of subtracting the temperature information a12 and the current information a16 from the manipulation quantity all and outputs a calculation result a14 from the output terminal 534 to the comparator 512.

Predetermined carrier information a13 is input to the negative input terminal 552 of the comparator 512. Here, as the carrier information a13, information of carrier waves in PWM is used, and, for example, triangular waves are used.

The calculation result a14 output from the calculator 511 is input to the positive input terminal 551 of the comparator 512.

The comparator 512 outputs a comparison result a15 based on a magnitude relationship between the carrier information a13 and the calculation result a14.

In the present embodiment, the control voltage based on the comparison result a15 is input to gate terminals of the switch elements 191 and 192 as the PWM control voltage.

Also, the PWM unit 171 outputs a control voltage obtained by inverting the control voltage for the switch elements 191 and 192 to gate terminals of the switch elements 193 and 194. Thereby, the switch elements 191 and 192 and the switch elements 193 and 194 are controlled so that their on/off operations are reversed from each other.

Also, the PWM unit 271 of the second converter controls a control voltage (a drive signal) for gate terminals of the switch elements 291 and 292 and a control voltage (a drive signal) for gate terminals of the switch elements 293 and 294, as in the control described with respect to the PWM unit 171 of the first converter.

Here, as in the example of FIG. 2, the operation voltage generator 501 shown in FIG. 3 may use temperature difference information instead of the temperature information a12.

The temperature difference information is information representing a difference between a temperature detected by the temperature sensor 151 of the first converter and a temperature detected by the temperature sensor 251 of the second converter and is generated in, for example, the PWM units 171 and 271.

As another example of the configuration, a configuration in which each of the PWM unit 171 of the first converter and the PWM unit 271 of the second converter performs control on the basis of both information about a current detected by the current detection circuit 152 and information about a current detected by the current detection circuit 252 may be used.

In this case, for example, information about the current detected by the current detection circuit 152 is also input to the PWM unit 271 of the second converter, and, similarly, information about the current detected by the current detection circuit 252 is also input to the PWM unit 171 of the first converter. In the operation voltage generator 501 shown in FIG. 3, current difference information is used instead of the current information a16.

The current difference information is information representing a difference between the information about the current detected by the current detection circuit 152 of the first converter and the information about the current detected by the current detection circuit 252 of the second converter and is generated in, for example, the PWM units 171 and 271.

Although the converter device 11 separately includes the PWM unit 171 of the first converter and the PWM unit 271 of the second converter in the present embodiment, some or all of functions provided in the PWM units 171 and 271 may be provided in a common controller as another example of the configuration.

As another example of the configuration, a controller that controls the PWM unit 171 of the first converter and the PWM unit 271 of the second converter may be provided. The controller may be configured using, for example, a microcomputer, and the information input to the PWM units 171 and 271 in the example of FIG. 3 is input to the microcomputer and the PWM units 171 and 271 are controlled on the basis of the input information.

Here, the circuit configuration of the operation voltage generator 501 shown in FIG. 3 is an example, and, for example, another circuit configuration that can obtain a similar control voltage (drive signal) may be used. For example, one or both of the temperature information a12 (or temperature difference information) and the current information a16 (or current difference information) may be introduced at another location such as a location of the carrier information a13.

Also, plus (+) and minus (−) signs of the signal may be adjusted by, for example, an inverting circuit.

Also, one or the other of the configuration using the temperature information and the configuration using the temperature difference information and one or the other of the configuration using the current information and the configuration using the current difference information may be used in any combination.

As described above, in the power supply device 1 according to the present embodiment, in the output circuit according to a parallel connection of the non-isolated converter, it is possible to perform control so that temperatures and currents of the switch elements are balanced according to the PWM control of the voltage mode. Thereby, in the converter device 11, the balance between the temperatures can be retained, and the balance between the currents can be retained, with respect to the plurality of converters.

Therefore, in the power supply device 1 according to the present embodiment, the temperatures of the switch elements of the plurality of converters can be balanced.

Also, in the power supply device 1 according to the present embodiment, in the converter device 11, it is possible to limit a cross current in a plurality of converters and the cross current limiting effect at the time of a low load is particularly large. That is, in the converter device 11, the cross current is reduced by balancing the currents in the plurality of converters.

Regarding the cross current, for example, even if current detection of a switching circuit is performed by a non-contact element (for example, a Hall element) such as a magnetic sensor or a choke coil as the current detection circuits 152 and 252, current information with sufficient accuracy can be obtained. Generally, for example, it is only necessary for the accuracy of the current not to be significantly high with respect to the cross current in many cases.

Here, when three or more converters are used, for example, it is only necessary to use the current difference information in at least two converters as the current difference information. As the current difference information, information of a difference between the currents in the two converters is used for all combinations of the two converters or other forms may be used.

### Third Embodiment

A schematic configuration of a power supply device according to the present embodiment is similar to that of the power supply device 1 shown in FIG. 1 according to the first embodiment. Thus, for convenience of description, the present embodiment will be described using reference signs which are the same as those of the parts shown in FIG. 1 with reference to the power supply device 1 shown in FIG. 1.

Also, in the present embodiment, the configurations of the PWM units 171 and 271 are schematically different from those of the first embodiment and the others are similar to those of the first embodiment. Therefore, the description of the similarities will be omitted or simplified.

Here, in the present embodiment, a manipulation quantity from a CV controller 52 to the PWM unit 171 and a manipulation quantity from the CV controller 52 to the PWM unit 271 are the same.

In the present embodiment, the configuration of the PWM unit 171 of a first converter is similar to the configuration of the PWM unit 271 of a second converter.

Here, the configuration of the PWM unit 171 will be described.

FIG. 4 is a diagram showing an example of a configuration of an operation voltage generator 601 of a current mode in the PWM unit 171 according to the embodiment (the third embodiment).

The operation voltage generator 601 includes a calculator 611, a comparator 612, a flip-flop 613, and an oscillator 614.

The calculator 611 includes a positive input terminal 631, a positive input terminal 632, and an output terminal 633.

The comparator 612 includes a positive input terminal 651, a negative input terminal 652, an output terminal 653, a positive power supply terminal 654, and a negative power supply terminal 655.

The flip-flop 613 has an S input terminal 671, an R input terminal 672, and a Q output terminal 673. The flip-flop 613 is an RS type flip-flop.

Information about a current input from the current detection circuit 152 to the PWM unit 171 (referred to as current information a23 for convenience of description) is input to the positive input terminal 631 of the calculator 611.

Information about a temperature output from the temperature sensor 151 (referred to as temperature information a22 for convenience of description) is input to the positive input terminal 632 of the calculator 611.

The calculator 611 performs a calculation operation of adding the current information a23 to the temperature information a22 and outputs a calculation result a24 from the output terminal 633 to the comparator 612.

A manipulation quantity a21 output from the CV controller 52 is input to the negative input terminal 652 of the comparator 612.

The calculation result a24 output from the calculator 611 is input to the positive input terminal 651 of the comparator 612.

The comparator 612 outputs a comparison result a25 based on a magnitude relationship between the manipulation quantity a21 and the calculation result a24 from the output terminal 653.

The comparison result a25 output from the comparator 612 is input to the R input terminal 672 of the flip-flop 613.

The oscillator 614 outputs predetermined trigger information a26. As the trigger information a26, for example, a signal having a predetermined frequency serving as a trigger may be used.

The trigger information a26 output from the oscillator 614 is input to the S input terminal 671 of the flip-flop 613.

The flip-flop 613 outputs an output result a27 based on the trigger information a26 and the comparison result a25 from the Q output terminal 673.

In the present embodiment, a control voltage based on the output result a27 is input as a PWM control voltage to gate terminals of the switch elements 191 and 192.

Also, the PWM unit 171 outputs a control voltage obtained by inverting the control voltage for the switch elements 191 and 192 to gate terminals of the switch elements 193 and 194. Thereby, the switch elements 191 and 192 and the switch elements 193 and 194 are controlled so that their on/off operations are reversed from each other.

Also, the PWM unit 271 of the second converter controls the control voltage for gate terminals of the switch elements 291 and 292 and the control voltage for gate terminals of the switch elements 293 and 294 as in the control described with respect to the PWM unit 171 of the first converter.

Here, in the present embodiment, a case in which the PWM unit 171 of the first converter performs control on the basis of the detection result of the temperature sensor 151 and the PWM unit 271 of the second converter performs control on the basis of the detection result of the temperature sensor 251 is shown.

As another example of the configuration, a configuration in which each of the PWM unit 171 of the first converter and the PWM unit 271 of the second converter performs control on the basis of both the detection result of the temperature sensor 151 and the detection result of the temperature sensor 251 may be used.

In this case, for example, information about the detected temperature is also output from the temperature sensor 151 of the first converter to the PWM unit 271 of the second converter. Likewise, information about the detected temperature is also output from the temperature sensor 251 of the second converter to the PWM unit 171 of the first converter. In the operation voltage generator 601 shown in FIG. 4, temperature difference information is used instead of the temperature information a22.

The temperature difference information is information representing a difference between the temperature detected by the temperature sensor 151 of the first converter and the temperature detected by the temperature sensor 251 of the second converter and is generated in, for example, the PWM units 171 and 271.

Here, the circuit configuration of the operation voltage generator 601 shown in FIG. 4 is an example, and for example, another circuit configuration that can obtain a similar control voltage (drive signal) may be used. For example, the temperature information a22 (or temperature difference information) may be introduced at another location such as a location of the manipulation quantity a21.

Also, plus (+) and minus (−) signs of the signal may be adjusted by, for example, an inverting circuit.

As described above, in the power supply device 1 according to the present embodiment, control can be performed so that the temperatures of the switch elements are balanced by the PWM control of the current mode in the output circuit according to a parallel connection of the non-isolated converters. Thereby, in the converter device 11, the balance between the temperatures can be retained for the plurality of converters.

Therefore, in the power supply device 1 according to the present embodiment, the temperatures of the switch elements of the plurality of converters can be balanced.

### Fourth Embodiment

A schematic configuration of a power supply device according to the present embodiment is similar to that of the power supply device 1 shown in FIG. 1 according to the first embodiment. Thus, for convenience of description, the present embodiment will be described using reference signs which are the same as those of the parts shown in FIG. 1 with reference to the power supply device 1 shown in FIG. 1.

Also, in the present embodiment, the configurations of the PWM units 171 and 271 are schematically different from those of the first embodiment and the others are similar to those of the first embodiment. Therefore, the description of the similarities will be omitted or simplified.

Here, in the present embodiment, a manipulation quantity from a CV controller 52 to the PWM unit 171 and a manipulation quantity from the CV controller 52 to the PWM unit 271 are the same.

In the present embodiment, the configuration of the PWM unit 171 of a first converter is similar to the configuration of the PWM unit 271 of a second converter.

Here, the configuration of the PWM unit 171 will be described.

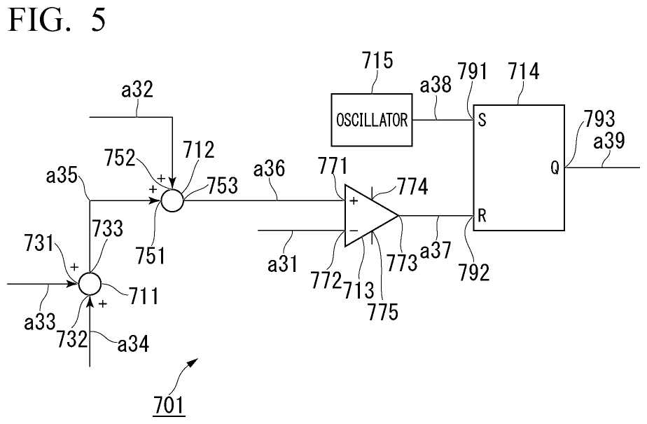

FIG. 5 is a diagram showing an example of a configuration of an operation voltage generator 701 of the current mode in the PWM unit 171 according to the embodiment (the fourth embodiment).

The operation voltage generator 701 includes a calculator 711, a calculator 712, a comparator 713, a flip-flop 714, and an oscillator 715.

The calculator 711 has a positive input terminal 731, a positive input terminal 732, and an output terminal 733.

The calculator 712 has a positive input terminal 751, a positive input terminal 752, and an output terminal 753.

The comparator 713 has a positive input terminal 771, a negative input terminal 772, an output terminal 773, a positive power supply terminal 774, and a negative power supply terminal 775.

The flip-flop 714 has an S input terminal 791, an R input terminal 792, and a Q output terminal 793. The flip-flop 714 is an RS type flip-flop.

Information about a current input from the current detection circuit 152 to the PWM unit 171 (referred to as current information a33 for convenience of description) is input to the positive input terminal 731 of the calculator 711.

Information about a carrier (referred to as carrier information a34 for convenience of description) is input to the positive input terminal 732 of the calculator 711. Here, as the carrier information a34, information of carrier waves in PWM is used, and, for example, triangular waves are used.

The calculator 711 performs a calculation operation of adding the current information a33 to the carrier information a34 and outputs a calculation result a35 from the output terminal 733 to the calculator 712.

The calculation result a35 output from the calculator 711 is input to the positive input terminal 751 of the calculator 712.

Information about a temperature output from the temperature sensor 151 (referred to as temperature information a32 for convenience of description) is input to the positive input terminal 752 of the calculator 712.

The calculator 712 performs a calculation operation of adding the calculation result a35 to the temperature information a32 and outputs a calculation result a36 from the output terminal 753 to the comparator 713.

A manipulation quantity a31 output from the CV controller 52 is input to the negative input terminal 772 of the comparator 713.

A calculation result a36 output from the calculator 712 is input to the positive input terminal 771 of the comparator 713.

The comparator 713 outputs a comparison result a37 based on a magnitude relationship between the manipulation quantity a31 and the calculation result a36 from the output terminal 773.

The comparison result a37 output from the comparator 713 is input to the R input terminal 792 of the flip-flop 714.

The oscillator 715 outputs predetermined trigger information a38. As the trigger information a38, for example, a signal having a predetermined frequency serving as a trigger may be used.

The trigger information a38 output from the oscillator 715 is input to the S input terminal 791 of the flip-flop 714.

The flip-flop 714 outputs an output result a39 based on the trigger information a38 and the comparison result a37 from the Q output terminal 793.

In the present embodiment, a control voltage based on the output result a39 is input as a PWM control voltage to the gate terminals of the switch elements 191 and 192.

Also, the PWM unit 171 outputs a control voltage obtained by inverting the control voltage for the switch elements 191 and 192 to the gate terminals of the switch elements 193 and 194. Thereby, the switch elements 191 and 192 and the switch elements 193 and 194 are controlled so that their on/off operations are reversed from each other.

Also, the PWM unit 271 of the second converter controls a control voltage for the gate terminals of the switch elements 291 and 292 and a control voltage for the gate terminals of the switch elements 293 and 294, as in the control described with respect to the PWM unit 171 of the first converter.

Here, as in the example of FIG. 4, the operation voltage generator 701 shown in FIG. 5 may use temperature difference information instead of the temperature information a32.

The temperature difference information is information representing a difference between a temperature detected by the temperature sensor 151 of the first converter and a temperature detected by the temperature sensor 251 of the second converter, and is generated in, for example, the PWM units 171 and 271.

Here, the circuit configuration of the operation voltage generator 701 shown in FIG. 5 is an example, and, for example, another circuit configuration that can obtain a similar control voltage (drive signal) may be used. For example, one or both of the temperature information a32 (or temperature difference information) and the carrier information a34 may be introduced at another location such as a location of the manipulation quantity a31.

Also, plus (+) and minus (−) signs of the signal may be adjusted by, for example, an inverting circuit.

As described above, in the power supply device 1 according to the present embodiment, control can be performed so that the temperatures of the switch elements are balanced by the PWM control of the current mode in the output circuit according to a parallel connection of the non-isolated converters. Thereby, in the converter device 11, the balance between the temperatures can be retained for the plurality of converters.

Therefore, in the power supply device 1 according to the present embodiment, the temperatures of the switch elements of the plurality of converters can be balanced.

### Fifth Embodiment

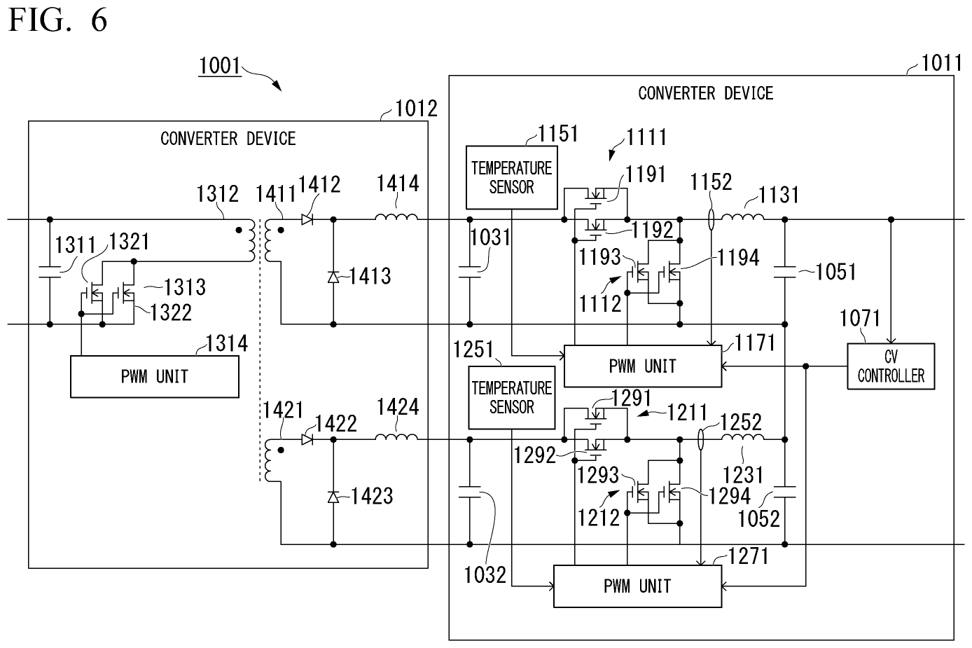

FIG. 6 is a diagram showing a circuit configuration of a power supply device 1001 including converter devices 1011 and 1012 according to an embodiment (the fifth embodiment).

The power supply device 1001 includes a converter device 1011 using a non-isolated converter, and a converter device 1012 using a converter that is isolated (also referred to as an isolated converter for convenience of description).

In the example of FIG. 6, the converter device 1012 of a previous stage and the converter device 1011 of a subsequent stage are connected in series.

The converter device 1011 of the subsequent stage includes a converter circuit unit including two converters. In the present embodiment, for convenience of description, the above two converters will be referred to as a first converter and a second converter, respectively.

The first converter and the second converter are non-isolated converters, respectively.

Also, in FIG. 6, a voltage source (a power supply unit) connected to a stage previous to the converter device 1012 of the previous stage is not shown. As the voltage source, for example, a DC voltage source similar to the example of FIG. 1 according to the first embodiment and the like may be used.

Also, in FIG. 6, a subsequent-stage circuit, which is a circuit connected to a stage subsequent to the converter device 1011 of the subsequent stage, is not shown. As the subsequent-stage circuit, for example, a subsequent-stage circuit similar to the example of FIG. 1 according to the first embodiment may be used.

Although the subsequent-stage circuit is not included in the power supply device 1001 in the present embodiment, the subsequent-stage circuit may be included in the power supply device 1001 as another example of the configuration.

The converter device 1012 of the previous stage will be described.

The converter device 1012 includes a capacitor 1311, a primary winding 1312 of a transformer, a switch unit 1313, and a PWM unit 1314 as circuit units on a primary side of the transformer including the primary winding 1312 and the secondary winding 1411.

The switch unit 1313 includes a switch element 1321 and a switch element 1322.

In the present embodiment, each of the switch elements 1321 and 1322 is configured using a field effect transistor (FET).

The converter device 1012 includes circuit units of a first converter side and circuit units of a second converter side in the converter device 1011 of the subsequent stage as circuit units on a secondary side of the transformer.

The converter device 1012 includes a secondary winding 1411, a diode 1412, a diode 1413, and a coil 1414 as the circuit units of the first converter side in the circuit units on the secondary side of the transformer.

The converter device 1012 includes a secondary winding 1421, a diode 1422, a diode 1423, and a coil 1424 as the circuit units of the second converter side in the circuit units on the secondary side of the transformer.

A connection relationship between parts in the converter device 1012 will be described.

A capacitor 1311 of an input side is connected between a high-potential side and a low-potential side of two output terminals of a voltage source (not shown).

The high-potential side of both terminals of the capacitor 1311 is connected to one end of the primary winding 1312.

The other end of the primary winding 1312 is connected to the drain terminal of the switch element 1321 and the drain terminal of the switch element 1322. The switch element 1321 and the switch element 1322 are disposed in parallel.

The low-potential side of both terminals of the capacitor 1311 is connected to the source terminal of the switch element 1321 and the source terminal of the switch element 1322.

The PWM unit 1314 controls a control voltage (a drive signal) that is output to a gate terminal of the switch element 1321 and a gate terminal of the switch element 1322.

In the circuit unit of the first converter side in the circuit unit on the secondary side of the transformer, the high-potential side of both ends of the secondary winding 1411 is connected to an anode of the diode 1412.

A cathode of the diode 1412 is connected to one end of the coil 1414.

The low-potential side of both ends of the secondary winding 1411 is connected to an anode of the diode 1413.

A cathode of the diode 1413 is connected to the cathode of the diode 1412.

In the circuit unit of the second converter side in the circuit unit on the secondary side of the transformer, the high-potential side of both ends of the secondary winding 1421 is connected to an anode of the diode 1422.

A cathode of the diode 1422 is connected to one end of the coil 1424.

The low-potential side of both ends of the secondary winding 1421 is connected to an anode of the diode 1423.

A cathode of the diode 1423 is connected to the cathode of the diode 1422.

Here, in the example of FIG. 6, as the voltage source 71 shown in FIG. 1, a voltage generation circuit (a switching circuit) provided on the primary side of the transformer including the primary winding 1312 and the secondary winding 1411, the transformer, and a rectifying circuit and a smoothing circuit provided on the secondary side of the transformer are used.

Here, the rectifying circuit is configured using diodes 1412 and 1413.

Also, the smoothing circuit is configured using the coil 1414 and the capacitor 1031 for the first converter of the converter device 1011 and using the coil 1424 and the capacitor 1032 for the second converter of the converter device 1011.

Although a case in which the capacitor 1031 and the capacitor 1032 are included in the converter device 1011 has been described for convenience of description in the present embodiment, the capacitor 1031 and the capacitor 1032 may be included in the converter device 1012.

The converter device 1011 of the subsequent stage will be described.

The first converter includes a switch unit 1111, a switch unit 1112, a coil 1131, a temperature sensor 1151, a current detection circuit 1152, and a PWM unit 1171.

Here, the converter device 1011 includes a capacitor 1031 in a stage previous to the first converter.

Although an example of a configuration in which the capacitor 1031 is not included in the first converter is shown in the present embodiment, the capacitor 1031 may be included in the first converter as another example of the configuration.

The switch unit 1111 includes a switch element 1191 and a switch element 1192.

The switch unit 1112 includes a switch element 1193 and a switch element 1194.

In the present embodiment, each of the switch elements 1191 to 1194 is configured using a field effect transistor (FET).

The second converter includes a switch unit 1211, a switch unit 1212, a coil 1231, a temperature sensor 1251, a current detection circuit 1252, and a PWM unit 1271.

Here, the converter device 1011 includes a capacitor 1032 in a stage previous to the second converter.

Although an example of a configuration in which the capacitor 1032 is not included in the second converter is shown in the present embodiment, the capacitor 1032 may be included in the second converter as another example of the configuration.

The switch unit 1211 includes a switch element 1291 and a switch element 1292.

The switch unit 1212 includes a switch element 1293 and a switch element 1294.

In the present embodiment, each of the switch elements 1291 to 1294 is configured using a field effect transistor (FET).

Here, the converter device 1011 includes a capacitor 1051 serving as an output capacitor in a stage subsequent to the first converter.

Although an example of a configuration in which the capacitor 1051 is not included in the first converter is shown in the present embodiment, the capacitor 1051 may be included in the first converter as another example of the configuration.

Also, the converter device 1011 includes a capacitor 1052 serving as an output capacitor in a stage subsequent to the second converter.

Although an example of a configuration in which the capacitor 1052 is not included in the second converter is shown in the present embodiment, the capacitor 1052 may be included in the second converter as another example of the configuration.

The converter device 1011 includes a CV controller 1071 common between the first converter and the second converter.

Here, the configuration of the converter device 1011 is different from the configuration of the converter device 11 shown in FIG. 1 in that the first converter and the second converter in the converter device 11 shown in FIG. 1 are connected in parallel and the first converter and the second converter in the converter device 1011 are connected in series and others are similar therebetween.

Specifically, a capacitor 1051 is connected between the high-potential side and the low-potential side of the output terminal in a stage subsequent to the first converter.

Also, a capacitor 1052 is connected between the high-potential side and the low-potential side of the output terminal in the stage subsequent to the second converter.

The low-potential side of both terminals of the capacitor 1051 is connected to the high-potential side of both terminals of the capacitor 1052. Thereby, the first converter and the second converter are connected in series.

The high-potential side of both terminals of the capacitor 1051 and the low-potential side of both terminals of the capacitor 1052 become two ends on an output side of the converter device 1011.

For each of the PWM unit 1171 and the PWM unit 1271, for example, one of the operation voltage generators 401, 501, 601 and 701 shown in FIGS. 2 to 5 may be used.

As described above, in the power supply device 1001 according to the present embodiment, in the output circuit according to a serial connection of the non-isolated converters of the converter device 1011 of the subsequent stage, control can be performed so that the temperatures of the switch elements are balanced by the PWM control of a voltage mode or the PWM control of a current mode. Thereby, in the converter device 1011, the balance between the temperatures can be retained for the plurality of converters.

Although converters having the same circuit configuration are used as the plurality of converters in the converter device 1011 in the present embodiment, converters having different circuit configurations may be used as another example of the configuration.

Although a case in which two converters are connected in series is shown in the converter device 1011 has been described in the present embodiment, a configuration in which three or more converters are connected in series may be used as another example of the configuration.

### Sixth Embodiment

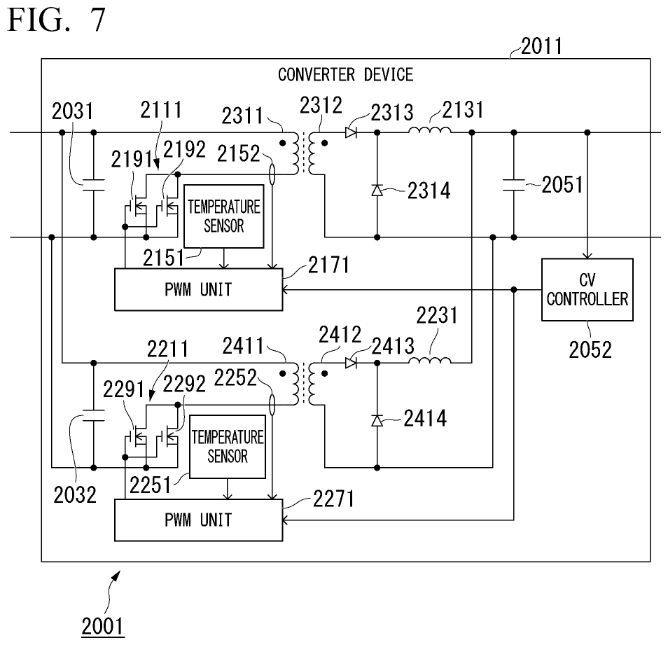

FIG. 7 is a diagram showing a circuit configuration of a power supply device 2001 including a converter device 2011 according to an embodiment (the sixth embodiment).

The power supply device 2001 includes a converter device 2011 using an isolated converter.

Also, in FIG. 7, a voltage source (a power supply unit) connected to a stage previous to the converter device 2011 is not shown. As the voltage source, for example, a DC voltage source similar to the example of FIG. 1 in the first embodiment and the like may be used.

Also, in FIG. 7, a subsequent-stage circuit, which is a circuit connected to a stage subsequent to the converter device 2011, is not shown. As the subsequent-stage circuit, for example, a subsequent-stage circuit similar to the example of FIG. 1 in the first embodiment may be used.

Although an example of a configuration in which the subsequent-stage circuit is not included in the power supply device 2001 is shown in the present embodiment, the subsequent-stage circuit may be included in the power supply device 2001 as another example of the configuration.

The converter device 2011 has a converter circuit unit including two converters. In the present embodiment, for convenience of description, the above two converters will be referred to as a first converter and a second converter, respectively.

The first converter and the second converter are isolated converters, respectively.

The converter device 2011 includes a capacitor 2051 serving as an output capacitor of a subsequent stage and a CV controller 2052 common between the first converter and the second converter.

The first converter includes a primary winding 2311 of a transformer, a switch unit 2111, a temperature sensor 2151 constituting a temperature detector, a current detection circuit 2152 constituting a current detector, and a PWM unit 2171 constituting a controller as circuit units on a primary side of the transformer including the primary winding 2311 and the secondary winding 2312.

The switch unit 2111 includes a switch element 2191 and a switch element 2192.

In the present embodiment, each of the switch elements 2191 and 2192 is configured using a field effect transistor (FET).

The first converter includes a secondary winding 2312 of the transformer, a diode 2313, a diode 2314, and a coil 2131 as circuit units on the secondary side of the transformer.

Here, the converter device 2011 includes a capacitor 2031 in a stage previous to the first converter.

Although an example of a configuration in which the capacitor 2031 is not included in the first converter is shown in the present embodiment, the capacitor 2031 may be included in the first converter as another example of the configuration.

In the example of FIG. 7, a rectifying circuit is configured using the diodes 2313 and 2314. Also, in the example of FIG. 7, a smoothing circuit is configured using the coil 2131 and the capacitor 2051.

The second converter includes a primary winding 2411 of the transformer, a switch unit 2211, a temperature sensor 2251 constituting a temperature detector, a current detection circuit 2252 constituting a current detector, and a PWM unit 2271 constituting a controller as circuit units on the primary side of the transformer including the primary winding 2411 and the secondary winding 2412.

The switch unit 2211 includes a switch element 2291 and a switch element 2292.

In the present embodiment, each of the switch elements 2291 and 2292 are configured using a field effect transistor (FET).

The second converter includes a secondary winding 2412 of the transformer, a diode 2413, a diode 2414, and a coil 2231 as circuit units on the secondary side of the transformer.

Here, the converter device 2011 includes a capacitor 2032 in a stage previous to the second converter.

Although an example of a configuration in which the capacitor 2032 is not included in the second converter is shown in the present embodiment, the capacitor 2032 may be included in the second converter as another example of the configuration.

In the example of FIG. 7, a rectifying circuit is configured using the diodes 2413 and 2414. Also, in the example of FIG. 7, a smoothing circuit is configured using the coil 2231 and the capacitor 2051.

A subsequent-stage circuit is connected to a stage subsequent to the capacitor 2051 of an output side common between the first converter and the second converter.

In the stage subsequent to the capacitor 2051 of the output side, the CV controller 2052 including a voltage detector is connected to the capacitor 2051 of the output side.

A connection relationship between parts in the first converter will be described.

The capacitor 2031 of an input side is connected between the high-potential side and the low-potential side of two output terminals of a voltage source (not shown).

The high-potential side of both terminals of the capacitor 2031 is connected to one end of the primary winding 2311 of the transformer.

The other end of the primary winding 2311 of the transformer is connected to a drain terminal of the switch element 2191 and a drain terminal of the switch element 2192 via the current detection circuit 2152. The switch element 2191 and the switch element 2192 are disposed in parallel.

The low-potential side of both terminals of the capacitor 2031 is connected to a source terminal of the switch element 2191 and a source terminal of the switch element 2192.

In the present embodiment, a component closest to a maximum rated temperature among the semiconductor elements including the switch elements 2191 and 2192 and the diodes 2313 and 2314 in the first converter is identified. The temperature sensor 2151 is disposed at a position where the temperature of the component closest to the maximum rated temperature can be detected in this way. In the example of FIG. 7, as an example, the switch element 2191 or the switch element 2192 is a component closest to the maximum rated temperature and the temperature sensor 2151 is disposed in the vicinity of the switch elements 2191 to 2192.

In the example of FIG. 7, the diodes 2313 and 2314 are also types of semiconductor elements.

The current detection circuit 2152 is connected between the drain terminal of the switch element 2191 and the drain terminal of the switch element 2192 and the other end (the low-potential side) of the primary winding 2311 of the transformer. As the current detection circuit 2152, a current transformer is used in the present embodiment, and a Hall element, a shunt resistor, or the like may be used as another example.

The PWM unit 2171 may be disposed at any location.

The high-potential side of both ends of the secondary winding 2312 of the transformer is connected to an anode of the diode 2313.

A cathode of the diode 2313 is connected to one end of the coil 2131.

The low-potential side of both ends of the secondary winding 2312 of the transformer is connected to an anode of the diode 2314.

A cathode of the diode 2314 is connected to the cathode of the diode 2313.

Here, one terminal (drain terminal) of each of the switch elements 2191 and 2192 constituting the switch unit 2111 is connected to the high-potential side of the two output terminals of the voltage source via the primary winding 2311 and the current detection circuit 2152.

A connection relationship between parts in the second converter will be described.

The capacitor 2032 of an input side is connected between the high-potential side and the low-potential side of two output terminals of a voltage source (not shown).

The high-potential side of both terminals of the capacitor 2032 is connected to one end of the primary winding 2411 of the transformer.

The other end of the primary winding 2411 of the transformer is connected to a drain terminal of the switch element 2291 and a drain terminal of the switch element 2292 via the current detection circuit 2252. The switch element 2291 and the switch element 2292 are disposed in parallel.

The low-potential side of both terminals of the capacitor 2032 is connected to a source terminal of the switch element 2291 and a source terminal of the switch element 2292.

In the present embodiment, a component closest to the maximum rated temperature among the semiconductor elements including the switch elements 2291 and 2292 and the diodes 2413 and 2414 in the second converter is identified. The temperature sensor 2251 is disposed at a position where the temperature of the component closest to the maximum rated temperature can be detected in this way. In the example of FIG. 7, as an example, the switch element 2291 or the switch element 2292 is a component closest to the maximum rated temperature, and the temperature sensor 2251 is disposed in the vicinity of the switch elements 2291 to 2292.

In the example of FIG. 7, the diodes 2413 and 2414 are also types of semiconductor elements.

The current detection circuit 2252 is connected between the drain terminal of the switch element 2291 and the drain terminal of the switch element 2292 and the other end (the low-potential side) of the primary winding 2411 of the transformer. As the current detection circuit 2252, a current transformer is used in the present embodiment, and a Hall element, a shunt resistor, or the like may be used as another example.

The PWM unit 2271 may be disposed at any location.

The high-potential side of both ends of the secondary winding 2412 of the transformer is connected to an anode of the diode 2413.

The cathode of the diode 2413 is connected to one end of the coil 2231.

The low-potential side of both ends of the secondary winding 2412 of the transformer is connected to an anode of the diode 2414.

The cathode of the diode 2414 is connected to the cathode of the diode 2413.

Here, one terminal (drain terminal) of each of the switch elements 2291 and 2292 constituting the switch unit 2211 is connected to the high-potential side of the two output terminals of the voltage source via the primary winding 2411 and the current detection circuit 2252.

On the output side of the first converter, an end that is opposite an end to which the diodes 2313 and 2314 are connected between both ends of the coil 2131 and the end of the low-potential side between both ends of the secondary winding 2312 become the end of the high-potential side and the end of the low-potential side, respectively.

On the output side of the second converter, an end that is opposite an end to which the diodes 2413 and 2414 are connected between both ends of the coil 2231 and the end of the low-potential side between both ends of the secondary winding 2412 become the end of the high-potential side and the end of the low-potential side, respectively.

The end of the high-potential side on the output side of the first converter is connected to the end of the high-potential side on the output side of the second converter. Also, the end of the low-potential side on the output side of the first converter is connected to the end of the low-potential side on the output side of the second converter. Thereby, the first converter and the second converter are connected in parallel.

The capacitor 2051 of the output side is connected between the end of the common high-potential side and the end of the common low-potential side on the output side in the first converter and the second converter.

A subsequent-stage circuit is connected to a stage subsequent to the capacitor 2051 of the output side common between the first converter and the second converter.

In the stage subsequent to the capacitor 2051 of the output side, the CV controller 2052 is connected to the capacitor 2051 of the output side.

The PWM control in the converter device 2011 will be described.

The PWM unit 2171 of the first converter will be described.

The CV controller 2052 controls a control quantity (a manipulation quantity) to be output to the PWM unit 2171 so that a voltage applied across both terminals of the capacitor 2051 of the output side becomes constant. As the operation of the CV controller 2052, for example, an operation similar to that of the conventional case may be performed.

The temperature sensor 2151 outputs information about a detected temperature to the PWM unit 2171. The information may be, for example, information representing a value of the detected temperature or other information based on the value of the detected temperature.

The current detection circuit 2152 detects a current flowing through the current detection circuit 2152 and outputs a current detection result to the PWM unit 2171. In the example of FIG. 7, the current is a current flowing through the switch unit 2111 (a parallel connection portion of the two switch elements 2191 and 2192) and is a current flowing through the primary winding 2311 of the transformer.

The PWM unit 2171 controls a control voltage (a drive signal) that is output to a gate terminal of the switch element 2191 and a gate terminal of the switch element 2192 so that the temperature detected by the temperature sensor 2151 is closed to a predetermined value on the basis of information about the voltage input from the CV controller 2052 and information about the temperature input from the temperature sensor 2151. The predetermined value may be, for example, a constant value or another value.

Also, the PWM unit 2171 further controls a control voltage (a drive signal) that is output to the gate terminal of the switch element 2191 and the gate terminal of the switch element 2192 on the basis of the information about the current input from the current detection circuit 2152.

In the present embodiment, a common control voltage is used between the switch element 2191 and the switch element 2192.

The PWM unit 2271 of the second converter will be described.

The CV controller 2052 controls a control quantity (a manipulation quantity) to be output to the PWM unit 2271 so that a voltage applied across both terminals of the capacitor 2051 of the output side becomes constant. Also, as the operation of the CV controller 2052, for example, an operation similar to that of the conventional case may be performed.

The temperature sensor 2251 outputs information about the detected temperature to the PWM unit 2271. The information may be, for example, information representing a value of the detected temperature or other information based on the value of the detected temperature.

The current detection circuit 2252 detects a current flowing through the current detection circuit 2252 and outputs a current detection result to the PWM unit 2271. In the example of FIG. 7, the current is a current flowing through the switch unit 2211 (a parallel connection portion of the two switch elements 2291 and 2292) and is a current flowing through the primary winding 2311 of the transformer.

The PWM unit 2271 controls a control voltage (a drive signal) that is output to a gate terminal of the switch element 2291 and a gate terminal of the switch element 2292 so that the temperature detected by the temperature sensor 2251 is closed to a predetermined value on the basis of information about the voltage input from the CV controller 2052 and information about the temperature input from the temperature sensor 2251. The predetermined value may be, for example, a constant value or another value.

Also, the PWM unit 2271 further controls a control voltage (a drive signal) that is output to the gate terminal of the switch element 2291 and the gate terminal of the switch element 2292 on the basis of the information about the current input from the current detection circuit 2252.

In the present embodiment, a common control voltage is used between the switch element 2291 and the switch element 2292.

Here, in the present embodiment, a manipulation quantity from the CV controller 2052 to the PWM unit 2171 and a manipulation quantity from the CV controller 2052 to the PWM unit 2271 are the same.

In the present embodiment, the configuration of the PWM unit 2171 of the first converter is similar to the configuration of the PWM unit 2271 of the second converter.

For each of the PWM unit 2171 and the PWM unit 2271, for example, one of the operation voltage generators 401, 501, 601 and 701 shown in FIGS. 2 to 5 may be used.

Also, as the current detection circuits 2152 and 2252, for example, a non-contact element (for example, a Hall element) such as a magnetic sensor may be used. In general, non-contact current detection by a non-contact element is implemented with low accuracy in low loss, so that high efficiency can be achieved when the non-contact element is used.

Although a circuit configuration in which the current is detected in each of the two converters is shown in the example of FIG. 7, a configuration in which a current is detected in one converter, a total current obtained by combining currents of the two converters is detected by a shunt resistor or the like, and a current of a result of subtracting the current in the one converter from the total current is estimated as a current in the other converter may be used as another example of the configuration. In this case, the shunt resistor is provided at a location where the total current obtained by combining the currents of the two converters flows.

As an example, in the parallel connection (interleave) of the two converters, a configuration in which an element (a non-contact element) that performs non-contact current detection is used as the current detection circuit 2152 in the one converter and the current in the other converter is estimated as the current of the result of subtracting the detected current in the one converter from the total current may be used.

Although the PWM unit 2171 of the first converter and the PWM unit 2271 of the second converter are separately provided in the converter device 2011 in the present embodiment, some or all of functions of the above PWM units 2171 and 2271 are provided in a common controller as another example of the configuration.

As another example of the configuration, a controller that controls the PWM unit 2171 of the first converter and the PWM unit 2271 of the second converter may be provided. The controller may be configured using, for example, a microcomputer, the information input to the PWM units 2171 and 2271 in the example of FIG. 7 may be input to the microcomputer, the PWM units 2171 and 2271 may be controlled on the basis of the input information, and an operation voltage (a drive signal) similar to that of the present embodiment may be generated.

For example, the controller that controls the PWM units 2171 and 2271 or the PWM units 2171 and 2271 may input information of temperatures detected by the temperature sensors 2151 and 2251 in the two converters and perform control so that a temperature difference between the two converters is closed to zero (0). As another example of the configuration, for example, the controller that controls the PWM units 2171 and 2271 or the PWM units 2171 and 2271 may input the information of the temperatures detected by the temperature sensors 2151 and 2251 in the two converters and perform control so that the temperature in each converter is closed to a predetermined value such as an average value between the temperatures in the two converters.

As described above, in the power supply device 2001 according to the present embodiment, the PWM units 2171 and 2271 in the plurality of converters control the drive signal for the switch element in each converter so that temperatures of the semiconductor elements having highest temperatures in the plurality of converters are closed to each other on the basis of the output voltage detection result and the temperature detection result.

According to the above configuration, in the power supply device 2001 according to the present embodiment, in the output circuit according to a parallel connection of the isolated converters, it is possible to perform control so that the temperatures of the switch elements are balanced by the PWM control of a voltage mode or the PWM control of a current mode. Thereby, in the converter device 2011, the balance between the temperatures can be retained for the plurality of converters.

Therefore, in the power supply device 2001 according to the present embodiment, the temperatures of the switch elements of the plurality of converters can be balanced.

Although converters having the same circuit configuration are used as a plurality of converters in the converter device 2011 in the present embodiment, converters having different circuit configurations may be used as another example of the configuration.

Although a case in which two converters are connected in parallel in the converter device 2011 is shown in the present embodiment, a configuration in which three or more converters are connected in parallel may be used as another example of the configuration.

When three or more converters are used, it is only necessary to use, for example, information of a difference between temperatures in at least two converters as the temperature difference information. As the temperature difference information, the information of the difference between temperatures of the two converters for all combinations of the two converters may be used or other forms may be used.

Likewise, when three or more converters are used, it is only necessary to use, for example, information of a difference between currents in at least two converters, as current difference information. As the current difference information, the information of the difference between currents of the two converters for all combinations of the two converters may be used or other forms may be used.

### Seventh Embodiment

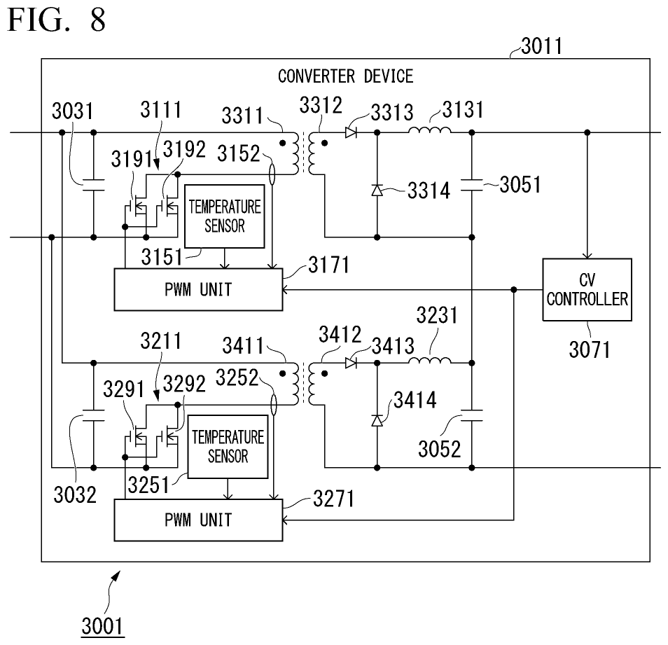

FIG. 8 is a diagram showing a circuit configuration of a power supply device 3001 including a converter device 3011 according to an embodiment (the seventh embodiment).

Also, in FIG. 8, a voltage source (a power supply unit) connected to a stage previous to the converter device 3011 is not shown. As the voltage source, for example, a DC voltage source similar to the example of FIG. 1 in the first embodiment and the like may be used.

Also, in FIG. 8, a subsequent-stage circuit, which is a circuit connected to a stage subsequent to the converter device 3011, is not shown. As the subsequent-stage circuit, for example, a subsequent-stage circuit similar to the example of FIG. 1 in the first embodiment may be used.

Although an example of a configuration in which the subsequent-stage circuit is not included in the power supply device 3001 is shown in the present embodiment, the subsequent-stage circuit may be included in the power supply device 3001 as another example of the configuration.

The converter device 3011 includes a converter circuit unit including two converters. In the present embodiment, for convenience of description, the above two converters will be referred to as a first converter and a second converter, respectively.

The first converter and the second converter are isolated converters, respectively.

The first converter includes a primary winding 3311 of a transformer, a switch unit 3111, a temperature sensor 3151, a current detection circuit 3152, and a PWM unit 3171 as circuit units on a primary side of the transformer.

The switch unit 3111 includes a switch element 3191 and a switch element 3192.

In the present embodiment, each of the switch elements 3191 and 3192 is configured using a field effect transistor (FET).

The first converter includes a secondary winding 3312, a diode 3313, a diode 3314, and a coil 3131 as circuit units on a secondary side of the transformer.

Here, the converter device 3011 includes a capacitor 3031 in a stage previous to the first converter.

Although an example of a configuration in which the capacitor 3031 is not included in the first converter is shown in the present embodiment, the capacitor 3031 may be included in the first converter as another example of the configuration.

The second converter includes a primary winding 3411 of the transformer, a switch unit 3211, a temperature sensor 3251, a current detection circuit 3252, and a PWM unit 3271 as circuit units on the primary side of the transformer.

The switch unit 3211 includes a switch element 3291 and a switch element 3292.

In the present embodiment, each of the switch elements 3291 and 3292 is configured using a field effect transistor (FET).

The second converter includes a secondary winding 3412, a diode 3413, a diode 3414, and a coil 3231 as circuit units on the secondary side of the transformer.

Here, the converter device 3011 includes a capacitor 3032 in a stage previous to the second converter.

Although an example of a configuration in which the capacitor 3032 is not included in the second converter is shown in the present embodiment, the capacitor 3032 may be included in the second converter as another example of the configuration.

The converter device 3011 includes a capacitor 3051 as an output capacitor in a stage subsequent to the first converter.

Although an example of a configuration in which the capacitor 3051 is not included in the first converter is shown in the present embodiment, the capacitor 3051 may be included in the first converter as another example of the configuration.

Also, the converter device 3011 includes a capacitor 3052 as an output capacitor in a stage subsequent to the second converter.

Although an example of a configuration in which the capacitor 3052 is not included in the second converter is shown in the present embodiment, the capacitor 3052 may be included in the second converter as another example of the configuration.

The converter device 3011 includes a CV controller 3071 common between the first converter and the second converter.

A subsequent-stage circuit is connected to a stage subsequent to the capacitors 3051 and 3052 on an output side of the first converter and the second converter.

In the stage subsequent to the capacitors 3051 and 3052 of the output side, the CV controller 3071 is connected to the capacitors 3051 and 3052 of the output side.

Here, the configuration of the converter device 3011 is schematically different from the configuration of the converter device 2011 shown in FIG. 7 in that the first converter and the second converter in the converter device 2011 shown in FIG. 7 are connected in parallel and the first converter and the second converter in the converter device 3011 are connected in series and others are similar therebetween.

Specifically, the capacitor 3051 is connected between the high-potential side and the low-potential side in the stage subsequent to the first converter.

Also, the capacitor 3052 is connected between the high-potential side and the low-potential side in the stage subsequent to the second converter.

The low-potential side of both terminals of the capacitor 3051 is connected to the high-potential side of both terminals of the capacitor 3052. Thereby, the first converter and the second converter are connected in series.

The high-potential side of both terminals of the capacitor 3051 and the low-potential side of both terminals of the capacitor 3052 becomes two ends on the output side of the converter device 3011 and the CV controller 3071 is connected to the two ends.

For each of the PWM unit 3171 and the PWM unit 3271, for example, one of the operation voltage generators 401, 501, 601 and 701 shown in FIGS. 2 to 5 may be used.

As described above, in the power supply device 3001 according to the present embodiment, in the output circuit according to a serial connection of the isolated converters, control may be performed so that the temperatures of the switch elements are balanced by the PWM control of a voltage mode or the PWM control of a current mode. Thereby, in the converter device 3011, the balance between the temperatures can be retained for the plurality of converters.

Therefore, in the power supply device 3001 according to the present embodiment, the temperatures of the switch elements of the plurality of converters can be balanced.

Although converters having the same circuit configuration are used as the plurality of converters in the converter device 3011 in the present embodiment, converters having different circuit configurations may be used as another example of the configuration.

Although a case in which two converters are connected in series in the converter device 3011 is shown in the present embodiment, a configuration in which three or more converters are connected in series may be used as another example of the configuration.

### [Current Detection Circuit and Form of Available Current Detection Position]

As the current detection circuit, for example, a current transformer, a Hall element, a shunt resistor, or the like may be used. Also, when the current transformer is used as the current detection circuit, the current is detected in a region where an alternating current (AC) flows.

Although an example of a position where the current in each converter is detected by the current transformer (also referred to as a current detection position for convenience of description) is shown in each of the above embodiments, another position may be used as the current detection position of the current transformer.

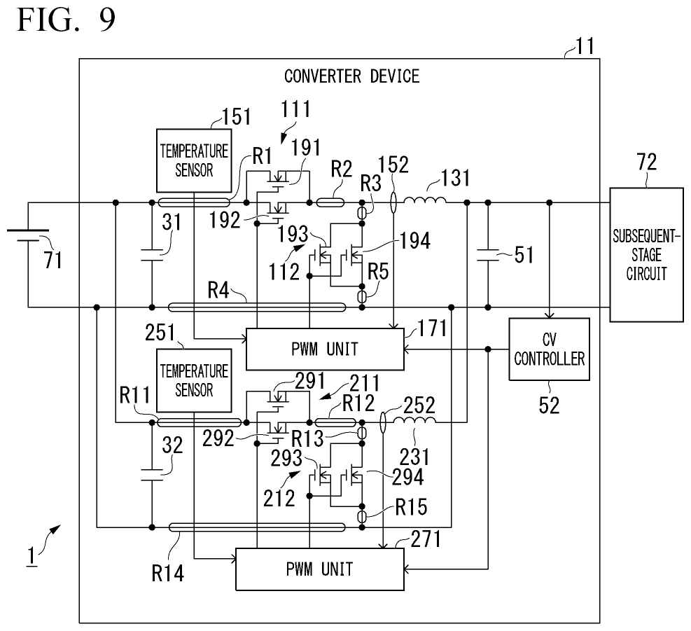

A specific description will be given with reference to FIGS. 9 to 12.

FIG. 9 is a diagram showing a circuit configuration of the power supply device 1 including the converter device 11 according to the embodiment (the first to fourth embodiments) and available current detection positions R1 to R5 and R11 to R15 of current transformers in the converters.

Circuit configurations of the converter device 11 and the power supply device 1 shown in FIG. 9 are the same as those shown in FIG. 1 and the components thereof are denoted by the same reference signs.

In the example of FIG. 9, in the first converter of the converter device 11, a current flowing through any position of the available current detection positions R1 to R5 may be detected instead of the position of the current detection circuit 152 shown in FIG. 1.

Likewise, in the example of FIG. 9, in the second converter of the converter device 11, a current flowing through any position of the available current detection positions R1 to R15 may be detected instead of the position of the current detection circuit 252 shown in FIG. 1.

As another example of the configuration, in the converter device 11, a shunt resistor may be provided in a subsequent stage of the converter device 11 and a current flowing through the shunt resistor may be detected. The current is a total current of the two converters combined. Also, the current in one converter may be subtracted from the total current and a subtraction result is the current (a total current) in the other converter.

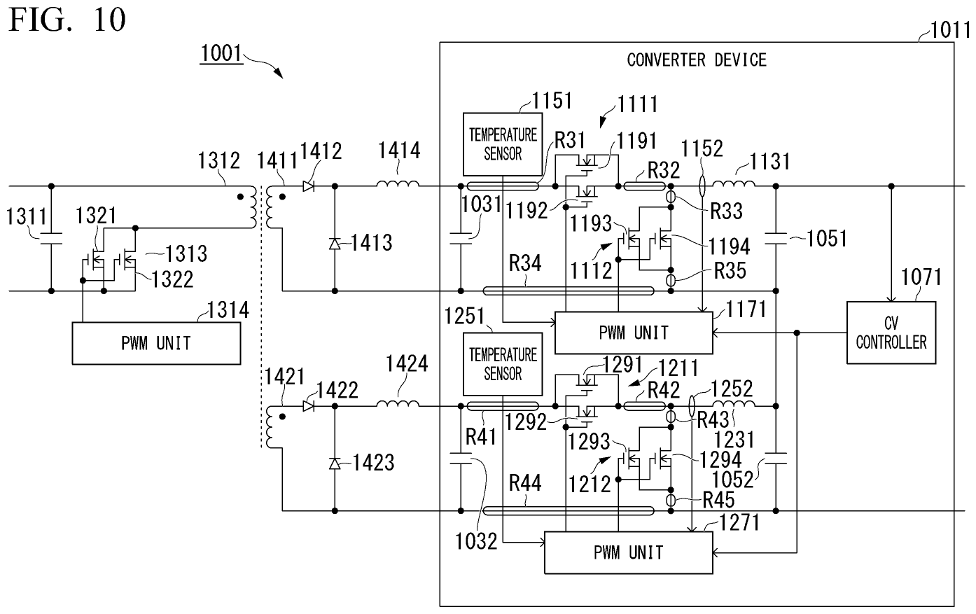

FIG. 10 is a diagram showing a circuit configuration of a power supply device 1001 including a converter device 1011 according to an embodiment (the fifth embodiment) and available current detection positions R31 to R35 and R41 to R45 of current transformers in the converters.

The circuit configurations of the converter device 1011 and the power supply device 1001 shown in FIG. 10 are the same as those shown in FIG. 6 and the components thereof are denoted by the same reference signs.

In the example of FIG. 10, in the first converter of the converter device 1011, a current flowing through any position of the available current detection positions R31 to R35 may be detected instead of the position of the current detection circuit 1152 shown in FIG. 6.

Likewise, in the example of FIG. 10, in the second converter of the converter device 1011, a current flowing through any position of the available current detection positions R41 to R45 may be detected instead of the position of the current detection circuit 1252 shown in FIG. 6.

As another example of the configuration, in the converter device 1011, a shunt resistor may be provided in a subsequent stage of the converter device 1011 and a current flowing through the shunt resistor may be detected. The current is a total current obtained by combining currents in the two converters. Also, the current in one converter may be subtracted from the total current and a subtraction result is the current (a total current) in the other converter.

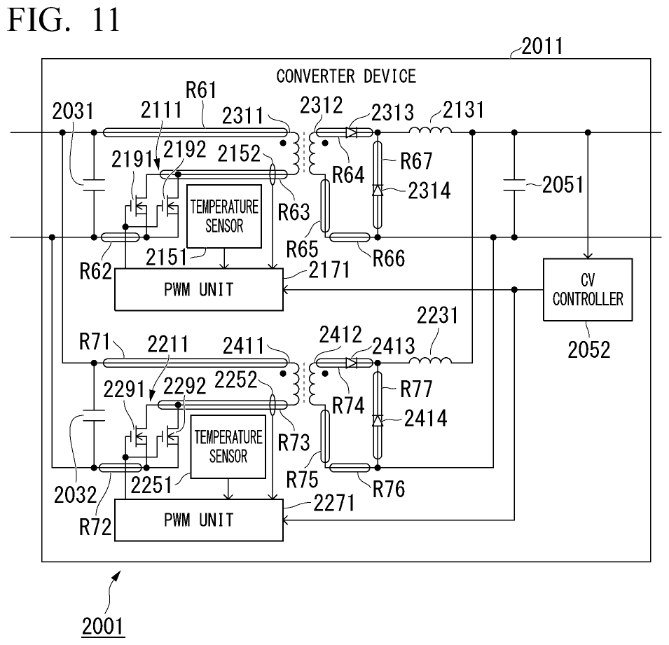

FIG. 11 is a diagram showing a circuit configuration of a power supply device 2001 including a converter device 2011 according to an embodiment (the sixth embodiment) and available current detection positions R61 to R67 and R71 to R77 of current transformers in the converters.

The circuit configurations of the converter device 2011 and the power supply device 2001 shown in FIG. 11 are the same as those shown in FIG. 7 and the components thereof are denoted by the same reference signs.

In the example of FIG. 11, in the first converter of the converter device 2011, a current flowing through any position of the available current detection positions R61 to R67 may be detected instead of the position of the current detection circuit 2152 shown in FIG. 7.

Likewise, in the example of FIG. 11, in the second converter of the converter device 2011, a current flowing through any position of the available current detection positions R71 to R77 may be detected instead of the position of the current detection circuit 2252 shown in FIG. 7.

As another example of the configuration, in the converter device 2011, a shunt resistor may be provided in a subsequent stage of the converter device 2011 and a current flowing through the shunt resistor may be detected. The current is a total current obtained by combining currents in the two converters. Also, the current in one converter may be subtracted from the total current and a subtraction result is the current (a total current) in the other converter.

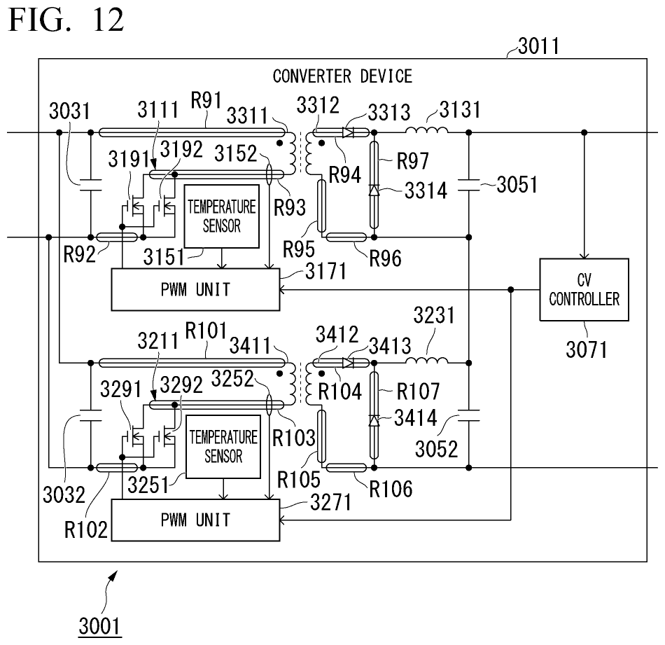

FIG. 12 is a diagram showing a circuit configuration of a power supply device 3001 including a converter device 3011 according to an embodiment (the seventh embodiment) and available current detection positions R91 to R97 and R101 to R107 of current transformers in the converters.

The circuit configurations of the converter device 3011 and the power supply device 3001 shown in FIG. 12 are the same as those shown in FIG. 8 and the components thereof are denoted by the same reference signs.

In the example of FIG. 12, in the first converter of the converter device 3011, a current flowing through any position of the available current detection positions R91 to R97 may be detected instead of the position of the current detection circuit 3152 shown in FIG. 8.

Likewise, in the example of FIG. 12, in the second converter of the converter device 3011, a current flowing through any position of the available current detection positions R101 to R107 may be detected instead of the position of the current detection circuit 3252 shown in FIG. 8.

As another example of the configuration, in the converter device 3011, a shunt resistor may be provided in a subsequent stage of the converter device 3011 and a current flowing through the shunt resistor may be detected. The current is a total current obtained by combining currents in the two converters. Also, the current in one converter may be subtracted from the total current and a subtraction result is the current (a total current) in the other converter.

### [Form of Temperature Detection in Converter]

In the above embodiments, in each converter, a component closest to a maximum rated temperature among semiconductor elements is identified and the temperature of the component closest to the maximum rated temperature is used for control. Thus, in the above embodiments, a case in which it is only necessary to provide one temperature sensor in one converter is shown.

As another example, in each converter, the component closest to the maximum rated temperature may be likely to change due to reasons of usage conditions and the like. In this case, for example, each converter may include a plurality of temperature sensors, and information about temperatures of a plurality of components may be detected by the temperature sensors. In this case, a configuration in which a maximum temperature (for example, a value closest to the maximum rated temperature) is extracted from the temperatures detected with respect to the plurality of components and PWM control is performed on the basis of the temperature may be used. For example, the above control may be performed using any controller such as a microcomputer.

Also, in each converter, a target semiconductor element whose temperature is to be detected by the temperature sensor and a target semiconductor element whose current is to be detected by the current detection circuit may be, for example, the same semiconductor element or different semiconductor elements.

For example, control by another detection method may be used instead of the configuration in which the temperature of the component closest to the maximum rated temperature is used for control.

As an example, in a configuration in which a circuit element having a primary side and a secondary side like a transformer is used, a target semiconductor element whose temperature is to be detected by the temperature sensor may be a secondary-side semiconductor element and a target semiconductor element whose current is to be detected by the current detection circuit may be a primary-side semiconductor element. In this case, the temperature detection circuit is isolated.

As another example, because both the temperature and the current can be detected on the same side (the primary side or the secondary side) in a configuration in which a target semiconductor element whose temperature is to be detected by the temperature sensor may be a primary-side (or secondary-side) semiconductor element and a target semiconductor element whose current is to be detected by the current detection circuit may be a primary-side (or secondary-side) semiconductor element, the circuit configuration and control are simpler and no isolation is required, for example, as compared with a configuration in which locations for detecting the temperature and the current become sides that are opposite each other.

### [Form of Control of Drive Signal for Switch Element of Converter]

Any form may be used as a form in which the controller controls the drive signal for the switch element in each converter so that temperatures of the semiconductor elements having highest temperatures in the plurality of converters are closed.

Here, for convenience of description, the semiconductor element having the highest temperature in each of the plurality of converters will be referred to as a target semiconductor element.

For two or more converters, the controller controls the current flowing through the target semiconductor element in each converter so that the temperatures of the target semiconductor elements of the converters are closed to each other and these temperatures are balanced.

For example, if there are two converters, the controller controls the current flowing through the target semiconductor element in each converter so that the temperature of the target semiconductor element of the converter in which the temperature of the target semiconductor element is higher and the temperature of the target semiconductor element of the converter in which temperature of the target semiconductor element is lower are closed to each other and the above temperatures are balanced when these two converters are compared.

As an example, the controller may perform control so that the temperature is closed to the temperature of the target semiconductor element of the converter in which the temperature of the target semiconductor element is higher and the current flowing through the target semiconductor element of the converter in which the temperature of the target semiconductor element is lower increases.

Here, in a configuration in which a load current quantity is determined by the load device side, the power supply side only outputs the current required by the load device side, and the load current is constant (hereinafter referred to as configuration A for the sake of description), when one current increases, the other current decreases. In this case, according to the control, as a result, the current flowing through the target semiconductor element of the converter in which the temperature of the target semiconductor element is higher decreases.

As another example, the controller may perform control so that the temperature is closed to the temperature of the target semiconductor element of the converter in which the temperature of the target semiconductor element is lower and a current flowing through the target semiconductor element of the converter in which temperature of the target semiconductor element is higher decreases.

Here, in the above-described configuration A, according to the control, the current flowing through the target semiconductor element of the converter in which the temperature of the target semiconductor element is lower increases.

Also, even if there are three or more converters, the controller controls the current flowing through the target semiconductor element in each converter so that the temperatures of the target semiconductor elements of the three or more converters are closed to each other and these temperatures are balanced.

As an example of a control form when there are three or more converters, a control form may be set in advance. In this case, for example, the form of control to be executed by the controller may be set in accordance with the number of converters and the temperature of the target semiconductor element in each converter. The control form may be determined on the basis of results of past experiments, may be determined on the basis of results of machine learning, or may be determined by theoretical design.

Also, as a control form when there are three or more converters, as another example, a form in which temperatures of target semiconductor elements of all converters are closed to each other by iteratively performing a process of changing the current flowing through the target semiconductor element in each converter by a predetermined quantity and acquiring the temperature of the target semiconductor element in each converter may be used.

For example, the controller may set a reference temperature on the basis of a temperature of a target semiconductor element of each of three or more converters and perform control so that the current flowing through the target semiconductor element of the converter in which the temperature of the target semiconductor element is higher than the reference temperature is decreased or may perform control so that the current flowing through the target semiconductor element of the converter in which the temperature of the target semiconductor element is lower than the reference temperature is increased. The reference temperature may be an average value of the temperatures of the target semiconductor elements of the three or more converters, may be a temperature in a predetermined order from the highest temperature, or may be another value. The temperature in a predetermined order from the highest temperature may be a median value when the total number of converters is odd.

As a specific example, in an actual circuit, converters having an identical configuration are used as a plurality of converters and an identical semiconductor element is often used. In this case, the maximum rated temperatures of the semiconductor elements in the plurality of converters are the same.

In this case, because the maximum rated temperatures of the semiconductor elements of the plurality of converters is the same, a highest temperature that has been detected becomes a temperature of a component closest to the maximum rated temperature. The controller performs control for making the detected temperatures of the switching elements having the highest temperature in the converters close with respect to the plurality of converters.

While preferred embodiments of the invention have been described and illustrated above, it should be understood that these are exemplary of the invention and are not to be considered as limiting. Additions, omissions, substitutions, and other modifications can be made without departing from the spirit or scope of the present invention. Accordingly, the invention is not to be considered as being limited by the foregoing description, and is only limited by the scope of the appended claims.

### DESCRIPTION OF REFERENCES

1, 1001, 2001, 3001 Power supply device
11, 1011, 1012, 2011, 3011 Converter device
31, 32, 51, 1031, 1032, 1051, 1052, 1311, 2031, 2032, 2051, 3031, 3032, 3051, 3052 Capacitor
52, 1071, 2052, 3071 CV controller
71 Voltage source
72 Subsequent-stage circuit
111, 112, 211, 212, 1111, 1112, 1211, 1212, 1313, 2111, 2211, 3111, 3211 Switch unit
131, 231, 1131, 1231, 1414, 1424, 2131, 2231, 3131, 3231 Coil
151, 251, 1151, 1251, 2151, 2251, 3151, 3251 Temperature sensor
152, 252, 1152, 1252, 2152, 2252, 3152, 3252 Current detection circuit
171, 271, 1171, 1271, 1314, 2171, 2271, 3171, 3271 PWM unit
191 to 194, 291 to 294, 1191 to 1194, 1291 to 1294, 1321, 1322, 2191, 2192, 2291, 2292, 3191, 3192, 3291, 3292 Switch element
401, 501, 601, 701 Operation voltage generator
411, 511, 611, 711, 712 Calculator
412, 512, 612, 713 Comparator
431, 451, 531, 551, 631, 632, 651, 731, 732, 751, 752, 771 Positive input terminal
432, 452, 532, 533, 552, 652, 772 Negative input terminal
433, 453, 534, 553, 633, 653, 733, 753, 773 Output terminal
454, 554, 654, 774 Positive power supply terminal
455, 555, 655, 775 Negative power supply terminal
613, 714 Flip-flop
614, 715 Oscillator
671, 791 S input terminal
672, 792 R input terminal
673, 793 Q output terminal
1312, 2311, 2411, 3311, 3411 Primary winding of transformer
1411, 1421, 2312, 2412, 3312, 3412 Secondary winding of transformer
1412, 1413, 1422, 1423, 2313, 2314, 2413, 2414, 3313, 3314, 3413, 3414 Diode
R1 to R5, R11 to R15, R31 to R35, R41 to R45, R61 to R67, R71 to R77, R91 to R97, R101 to R107 Available current detection position

What is claimed is:

1. A converter device comprising:
a plurality of converters;
a voltage detector;
a temperature detector; and
a controller,
wherein the plurality of converters are connected in series or in parallel,
wherein each of the plurality of converters includes at least one switch element configured to be controlled according to a drive signal,
wherein the voltage detector is configured to detect information about an output voltage of a converter circuit unit in which the plurality of converters are connected,
wherein the temperature detector is configured to detect information about temperatures of one or more of semiconductor elements including the switch element in each of the plurality of converters, and
wherein the controller is configured to control the drive signal for the switch element in each converter so that temperatures of semiconductor elements having highest temperatures in the plurality of converters are closed to each other on the basis of detection results of the voltage detector and detection results of the temperature detector.

2. The converter device according to claim 1, wherein the voltage detector is configured to detect information about the output voltage applied to an output capacitor of the converter circuit unit.

3. The converter device according to claim 1, further comprising a current detector,
wherein the current detector is configured to detect information about a current flowing through the semiconductor element in each of the plurality of converters, and
wherein the controller is further configured to control the drive signal on the basis of detection results of the current detector.

4. The converter device according to claim 2, further comprising a current detector,
wherein the current detector is configured to detect information about a current flowing through the semiconductor element in each of the plurality of converters, and
wherein the controller is further configured to control the drive signal on the basis of detection results of the current detector.

5. The converter device according to claim 3, wherein the current detector is configured to detect information about a current flowing through a current transformer connected to the semiconductor element.

6. The converter device according to claim 4, wherein the current detector is configured to detect information about a current flowing through a current transformer connected to the semiconductor element.

7. The converter device according to claim 3, wherein the controller is further configured to control the drive signal on the basis of trigger information having a predetermined frequency.

8. The converter device according to claim 4, wherein the controller is further configured to control the drive signal on the basis of trigger information having a predetermined frequency.

9. The converter device according to claim 5, wherein the controller is further configured to control the drive signal on the basis of trigger information having a predetermined frequency.

10. The converter device according to claim 6, wherein the controller is further configured to control the drive signal on the basis of trigger information having a predetermined frequency.

11. The converter device according to claim 1, wherein the controller is further configured to control the drive signal on the basis of carrier information.

12. The converter device according to claim 2, wherein the controller is further configured to control the drive signal on the basis of carrier information.

13. The converter device according to claim 3, wherein the controller is further configured to control the drive signal on the basis of carrier information.

14. The converter device according to claim 4, wherein the controller is further configured to control the drive signal on the basis of carrier information.

15. The converter device according to claim 5, wherein the controller is further configured to control the drive signal on the basis of carrier information.

16. The converter device according to claim 6, wherein the controller is further configured to control the drive signal on the basis of carrier information.

17. The converter device according to claim 7, wherein the controller is further configured to control the drive signal on the basis of carrier information.

18. The converter device according to claim 8, wherein the controller is further configured to control the drive signal on the basis of carrier information.

19. The converter device according to claim 9, wherein the controller is further configured to control the drive signal on the basis of carrier information.

20. A power supply device comprising:
the converter device according to claim 1; and
a power supply unit configured to supply a direct current (DC) power to the converter device.
